(19) United States
(12) Patent Application Publication
(10) Pub. No.: US 2022/0292749 A1
(43) Pub. Date: Sep. 15, 2022

(54) SCENE CONTENT AND ATTENTION SYSTEM

(71) Applicant: 3M INNOVATIVE PROPERTIES COMPANY, St. Paul, MN (US)

(72) Inventors: Brian E. Brooks, St. Paul, MN (US); Andrew W. Long, Woodbury, MN (US); Kenneth L. Smith, White Bear Lake, MN (US); James B. Snyder, Minneapolis, MN (US); Payas Tikotekar, Woodbury, MN (US); Carla H. Barnes, St. Paul, MN (US)

(21) Appl. No.: 17/636,196

(22) PCT Filed: Sep. 9, 2020
(86) PCT No.: PCT/IB2020/058388

§ 371 Date: Feb. 17, 2022

Related U.S. Application Data
(60) Provisional application No. 62/898,844, filed on Sep. 11, 2019.

(51) Int. Cl. G06T 11/60; G06V 10/40; G06V 20/58; B60K 35/00

(52) U.S. Cl. CPC G06T 11/60; G06V 10/40; G06V 20/58; B60K 35/00; G06T 2210/22; G06T 2210/61; G06F 3/013

(57) ABSTRACT

In some examples, a computing device includes one or more computer processors configured to receive, from an image capture device, an image of a physical scene that is viewable by an operator of a vehicle, wherein the physical scene is at least partially in a trajectory of the vehicle; receive, from an eye-tracking sensor, eye-tracking data that indicates a portion of the physical scene at which vision of the operator is directed; generate, based at least in part on excluding the portion of the physical scene at which vision of the operator is directed, a description of the physical scene; and perform at least one operation based at least in part on the description of the physical scene that is generated based at least in part on excluding the portion of the physical scene at which the vision of the operator is directed.

### TECHNICAL FIELD

The present application relates generally to machine vision and attention systems.

### BACKGROUND

Current and next generation vehicles may include those with a fully automated guidance systems, semi-automated guidance and fully manual vehicles. Semi-automated vehicles may include those with advanced driver assistance systems (ADAS) that may be designed to assist drivers avoid accidents. Automated and semi-automated vehicles may include adaptive features that may automate lighting, provide adaptive cruise control, automate braking, incorporate GPS/traffic warnings, connect to smartphones, alert driver to other cars or dangers, keep the driver in the correct lane, show what is in blind spots and other features. Infrastructure may increasingly become more intelligent by including systems to help vehicles move more safely and efficiently such as installing sensors, communication devices and other systems. Over the next several decades, vehicles of all types, manual, semi-automated and automated, may operate on the same roads and may need operate cooperatively and synchronously for safety and efficiency.

### SUMMARY

In general, this disclosure is directed to improving the relevance or quality of physical scene descriptions, which may be used to perform vehicle operations, by excluding portions of the physical scene at which the vision of a vehicle operator is directed during feature recognition. A computing device may apply feature recognition techniques to an image of a physical scene and classify or otherwise identify features in the image. A physical scene description generated using feature recognition techniques may include identifiers or natural language representations of the features identified or classified in the image. Vehicles (among other devices) and vehicle operators may use such physical scene descriptions to perform various operations including alerting the operator, applying braking, turning, or changing acceleration. Because a physical scene may include many features, some physical scene descriptions may be complex or contain more information than is necessary for a vehicle or vehicle operator to make decisions. This may be especially true if a vehicle operator is already looking at a portion of a physical scene that includes one or more features that the vehicle operator would or will react to. Overly complex or overly informative physical scene descriptions may cause a vehicle or vehicle operator to ignore or fail to recognize features (e.g., objects or conditions) in portions of a physical scene where the operator's vision is not directed. In such situations, the decision-making and/or safety of the vehicle or vehicle operator may be negatively impacted by ignoring or failing to recognize these features that are in portions of a physical scene other than where the operator's vision is directed.

Rather than generating a physical scene description based on an entire physical scene, techniques of this disclosure may generate a description of the physical scene without the portion of the physical scene at which operator's vision is directed. In this way, the physical scene description may exclude descriptions of features that are already in the portion of the physical scene where the vision of the operator is directed (and therefore the operator would or will react to). Physical scene descriptions that exclude descriptions of features that are already in the portion of the physical scene where the operator's vision is directed may be more concise, less complex, and/or more relevant to a vehicle or vehicle operator, thereby causing such physical scene descriptions generated using techniques of this disclosure to be more effective in vehicle or vehicle operator decision-making. In this way, safety and decision-making may be improved through the generation of physical scene descriptions of that exclude descriptions of features that are already in the portion of the physical scene at which vision of the operator is directed.

In some examples, a computing device includes one or more computer processors, and a memory comprising instructions that when executed by the one or more computer processors cause the one or more computer processors to: receive, from an image capture device, an image of a physical scene that is viewable by an operator of a vehicle, wherein the physical scene is at least partially in a trajectory of the vehicle; receive, from an eye-tracking sensor, eye-tracking data that indicates a portion of the physical scene at which vision of the operator is directed; generate, based at least in part on excluding the portion of the physical scene at which vision of the operator is directed, a description of the physical scene; and perform at least one operation based at least in part on the description of the physical scene that is generated based at least in part on excluding the portion of the physical scene at which the vision of the operator is directed.

The details of one or more examples of the disclosure are set forth in the accompanying drawings and the description below. Other features, objects, and advantages of the disclosure will be apparent from the description and drawings, and from the claims.

### BRIEF DESCRIPTION OF DRAWINGS

FIG. 1 is a block diagram illustrating an example system configured in accordance with this disclosure.

FIG. 2 is a block diagram illustrating an example computing device, in accordance with one or more aspects of the present disclosure.

FIGS. 3A and 3B are conceptual diagrams of example systems, in accordance with this disclosure.

FIG. 4 is a conceptual diagram of a physical scene in accordance with techniques of this disclosure.

FIG. 5 is a flow diagram illustrating example operations of a computing device in accordance with one or more techniques of this disclosure.

### DETAILED DESCRIPTION

Autonomous vehicles and advanced driver assistance systems (ADAS), which may be referred to as semi-autonomous vehicles, may use various sensors to perceive the environment, infrastructure, and other objects around the vehicle. These various sensors combined with onboard computer processing may allow the automated system to perceive complex information and respond to it more quickly than a human driver. In this disclosure, a vehicle may include any vehicle with or without sensors, such as a vision system, to interpret a vehicle pathway. A vehicle with vision systems or other sensors may take cues from the vehicle pathway. Some examples of vehicles may include the fully autonomous vehicles and ADAS equipped vehicles mentioned above, as well as unmanned aerial vehicles (UAV) (aka drones), human flight transport devices, underground pit mining ore carrying vehicles, forklifts, factory part or tool transport vehicles, ships and other watercraft and similar vehicles. A vehicle pathway (or “pathway”) may be a road, highway, a warehouse aisle, factory floor or a pathway not connected to the earth's surface. The vehicle pathway may include portions not limited to the pathway itself. In the example of a road, the pathway may include the road shoulder, physical structures near the pathway such as toll booths, railroad crossing equipment, traffic lights, the sides of a mountain, guardrails, and generally encompassing any other properties or characteristics of the pathway or objects/structures in proximity to the pathway. This will be described in more detail below.

In general, a pathway article may be any article or object embodied, attached, used, or placed at or near a pathway. For instance, a pathway article may be embodied, attached, used, or placed at or near a vehicle, pedestrian, micromobility device (e.g., scooter, food-delivery device, drone, etc.), pathway surface, intersection, building, or other area or object of a pathway. Examples of pathway articles include, but are not limited to signs, pavement markings, temporary traffic articles (e.g., cones, barrels), conspicuity tape, vehicle components, human apparel, stickers, or any other object embodied, attached, used, or placed at or near a pathway.

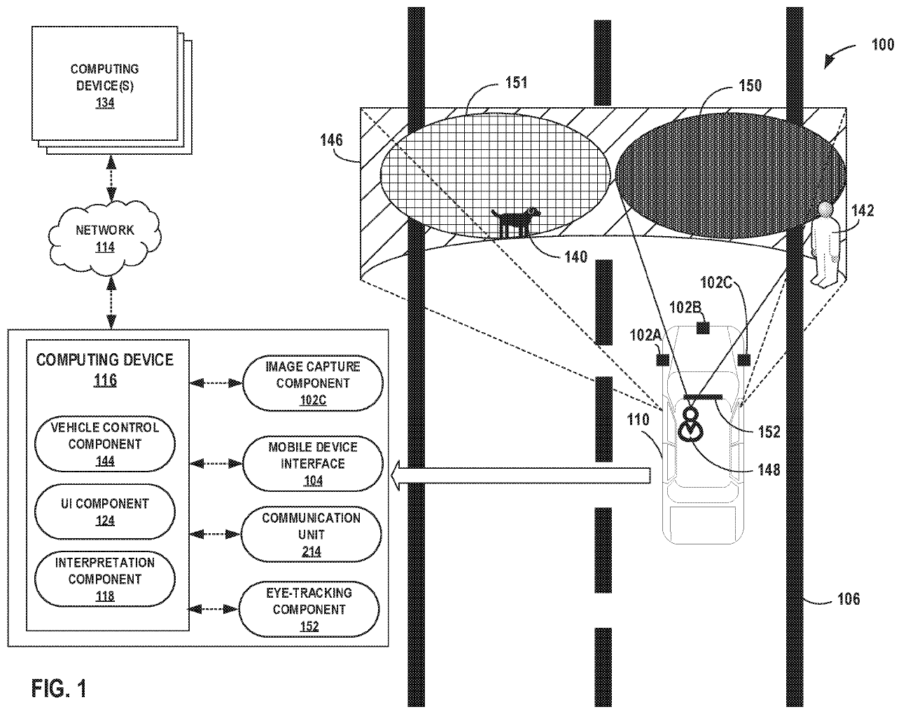

FIG. 1 is a block diagram illustrating an example system 100 configured in accordance with techniques of this disclosure. As described herein, vehicle generally refers to a vehicle with a vision systems and/or one or more sensors. A vehicle may interpret information from the vision system and other sensors, make decisions and take actions to navigate the vehicle pathway.

As shown in FIG. 1, system 100 includes vehicle 110 that may operate on vehicle pathway 106 and that includes light sensing devices 102A-102C and computing device 116. In some examples, a light sensing device may be an image capture device, such as a still- or moving-image camera. Any number of image capture devices may be possible and may positioned or oriented in any direction from the vehicle including rearward, forward and to the sides of the vehicle. In the example of FIG. 1, light sensing devices 102 may capture images and/or generate data that describe an environment surrounding at least a portion of vehicle 110.

As noted above, vehicle 110 of system 100 may be an autonomous or semi-autonomous vehicle, such as an ADAS. In some examples vehicle 110 may include occupants that may take full or partial control of vehicle 110. Vehicle 110 may be any type of vehicle designed to carry passengers or freight including small electric powered vehicles, large trucks or lorries with trailers, vehicles designed to carry crushed ore within an underground mine, or similar types of vehicles. Vehicle 110 may include lighting, such as headlights in the visible light spectrum as well as light sources in other spectrums, such as infrared. Vehicle 110 may include other sensors such as radar, sonar, lidar, GPS and communication links for the purpose of sensing the vehicle pathway, other vehicles in the vicinity, environmental conditions around the vehicle and communicating with infrastructure. For example, a rain sensor may operate the vehicles windshield wipers automatically in response to the amount of precipitation, and may also provide inputs to the onboard computing device 116.

As shown in FIG. 1, vehicle 110 of system 100 may include light sensing devices 102A-102C, collectively referred to as light sensing devices 102. Light sensing devices 102 may convert light or electromagnetic radiation sensed by one or more image capture sensors into information, such as digital image or bitmap comprising a set of pixels. Other devices, such as LiDAR, may be similarly used for articles and techniques of this disclosure. In the example of FIG. 1, each pixel may have chrominance and/or luminance components that represent the intensity and/or color of light or electromagnetic radiation. In general, light sensing devices 102 may be used to gather information about an environment surrounding a vehicle, which may include pathway 106. Light sensing devices 102 may send image capture information to computing device 116 via image capture component 102C. Light sensing devices 102 may capture any features of an environment surrounding vehicle 110. Examples of such features may include lane markings, centerline markings, edge of roadway or shoulder markings, other vehicles, pedestrians, or objects at or near pathway 106, such as dog 140 and pedestrian 142, as well as the general shape of the vehicle pathway. The general shape of a vehicle pathway may include turns, curves, incline, decline, widening, narrowing or other characteristics. Light sensing devices 102 may have a fixed field of view or may have an adjustable field of view. An image capture device with an adjustable field of view may be configured to pan left and right, up and down relative to vehicle 110 as well as be able to widen or narrow focus. In some examples, light sensing devices 102 may include a first lens and a second lens and/or first and second light sources, such that images may be captured using different light wavelength spectrums.

Light sensing devices 102 may include one or more image capture sensors and one or more light sources. In some examples, light sensing devices 102 may include image capture sensors and light sources in a single integrated device. In other examples, image capture sensors or light sources may be separate from or otherwise not integrated in light sensing devices 102. As described above, vehicle 110 may include light sources separate from light sensing devices 102. Examples of image capture sensors within light sensing devices 102 may include semiconductor charge-coupled devices (CCD) or active pixel sensors in complementary metal-oxide-semiconductor (CMOS) or N-type metal-oxide-semiconductor (NMOS, Live MOS) technologies. Digital sensors include flat panel detectors. In one example, light sensing devices 102 includes at least two different sensors for detecting light in two different wavelength spectrums.

In some examples, one or more light sources include a first source of radiation and a second source of radiation. In some embodiments, the first source of radiation emits radiation in the visible spectrum, and the second source of radiation emits radiation in the near infrared spectrum. In other embodiments, the first source of radiation and the second source of radiation emit radiation in the near infrared spectrum. Light sources may emit radiation in the near infrared spectrum.

In some examples, light sensing devices 102 capture frames at 50 frames per second (fps). Other examples of frame capture rates include 60, 30 and 25 fps. It should be apparent to a skilled artisan that frame capture rates are dependent on application and different rates may be used, such as, for example, 100 or 200 fps. Factors that affect required frame rate are, for example, size of the field of view (e.g., lower frame rates can be used for larger fields of view, but may limit depth of focus), and vehicle speed (higher speed may require a higher frame rate).

In some examples, light sensing devices 102 may include at least more than one channel. The channels may be optical channels. The two optical channels may pass through one lens onto a single sensor. In some examples, light sensing devices 102 includes at least one sensor, one lens and one band pass filter per channel. The band pass filter permits the transmission of multiple near infrared wavelengths to be received by the single sensor. The at least two channels may be differentiated by one of the following: (a) width of band (e.g., narrowband or wideband, wherein narrowband illumination may be any wavelength from the visible into the near infrared); (b) different wavelengths (e.g., narrowband processing at different wavelengths can be used to enhance features of interest, such as, for example, an enhanced sign of this disclosure, while suppressing other features (e.g., other objects, sunlight, headlights); (c) wavelength region (e.g., broadband light in the visible spectrum and used with either color or monochrome sensors); (d) sensor type or characteristics; (e) time exposure; and (f) optical components (e.g., lensing).

In some examples, light sensing devices 102 may include an adjustable focus function. For example, light sensing device 102B may have a wide field of focus that captures images along the length of vehicle pathway 106. Computing device 116 may control light sensing device 102A to shift to one side or the other of vehicle pathway 106 and narrow focus to capture the image of dog 140, pedestrian 142, or other features along vehicle pathway 106. The adjustable focus may be physical, such as adjusting a lens focus, or may be digital, similar to the facial focus function found on desktop conferencing cameras. In the example of FIG. 1, light sensing devices 102 may be communicatively coupled to computing device 116 via image capture component 102C. Image capture component 102C may receive image information from the plurality of image capture devices, such as light sensing devices 102, perform image processing, such as filtering, amplification and the like, and send image information to computing device 116.

Other components of vehicle 110 that may communicate with computing device 116 may include image capture component 102C, described above, mobile device interface 104, and communication unit 214. In some examples image capture component 102C, mobile device interface 104, and communication unit 214 may be separate from computing device 116 and in other examples may be a component of computing device 116.

Mobile device interface 104 may include a wired or wireless connection to a smartphone, tablet computer, laptop computer or similar device. In some examples, computing device 116 may communicate via mobile device interface 104 for a variety of purposes such as receiving traffic information, address of a desired destination or other purposes. In some examples computing device 116 may communicate to external networks 114, e.g. the cloud, via mobile device interface 104. In other examples, computing device 116 may communicate via communication units 214.

One or more communication units 214 of computing device 116 may communicate with external devices by transmitting and/or receiving data. For example, computing device 116 may use communication units 214 to transmit and/or receive radio signals on a radio network such as a cellular radio network or other networks, such as networks 114. In some examples communication units 214 may transmit and receive messages and information to other vehicles. In some examples, communication units 214 may transmit and/or receive satellite signals on a satellite network such as a Global Positioning System (GPS) network.

In the example of FIG. 1, computing device 116 includes vehicle control component 144 and user interface (UI) component 124 and an interpretation component 118. Components 118, 144, and 124 may perform operations described herein using software, hardware, firmware, or a mixture of both hardware, software, and firmware residing in and executing on computing device 116 and/or at one or more other remote computing devices. In some examples, components 118, 144 and 124 may be implemented as hardware, software, and/or a combination of hardware and software.

Computing device 116 may execute components 118, 124, 144 with one or more processors. Computing device 116 may execute any of components 118, 124, 144 as or within a virtual machine executing on underlying hardware. Components 118, 124, 144 may be implemented in various ways. For example, any of components 118, 124, 144 may be implemented as a downloadable or pre-installed application or “app.” In another example, any of components 118, 124, 144 may be implemented as part of an operating system of computing device 116. Computing device 116 may include inputs from sensors not shown in FIG. 1 such as engine temperature sensor, speed sensor, tire pressure sensor, air temperature sensors, an inclinometer, accelerometers, light sensor, and similar sensing components.

UI component 124 may include any hardware or software for communicating with a user of vehicle 110. In some examples, UI component 124 includes outputs to a user such as displays, such as a display screen, indicator or other lights, audio devices to generate notifications or other audible functions. UI component 24 may also include inputs such as knobs, switches, keyboards, touch screens or similar types of input devices.

Vehicle control component 144 may include for example, any circuitry or other hardware, or software that may adjust one or more functions of the vehicle. Some examples include adjustments to change a speed of the vehicle, change the status of a headlight, changing a damping coefficient of a suspension system of the vehicle, apply a force to a steering system of the vehicle or change the interpretation of one or more inputs from other sensors. For example, an IR capture device may determine an object near the vehicle pathway has body heat and change the interpretation of a visible spectrum image capture device from the object being a non-mobile structure to a possible large animal that could move into the pathway. Vehicle control component 144 may further control the vehicle speed as a result of these changes. In some examples, the computing device initiates the determined adjustment for one or more functions of the vehicle based on the machine-perceptible information in conjunction with a human operator that alters one or more functions of the vehicle based on the human-perceptible information.

Interpretation component 118 may implement one or more techniques of this disclosure.

For example, interpretation component 118 may receive, from an image capture component 102C, an image of physical scene 146 that is viewable by operator 148 of vehicle 110. Physical scene 146, as shown in FIG. 1, may be at least partially in a trajectory of vehicle 110. Interpretation component 118 may receive, from eye-tracking component 152, eye-tracking data that indicates a portion 150 of physical scene 146 at which vision of operator 148 is directed. Interpretation component 118 may generate, based at least in part on excluding portion 150 of the physical scene at which the vision of operator 148 is directed, a description of physical scene 146. Interpretation component 118 may perform at least one operation based at least in part on the description of physical scene 146 that is generated based at least in part on excluding portion 150 of physical scene 146 at which the vision of operator 148 is directed.

In some examples, vehicle 110 may include eye-tracking component 152. Eye-tracking component 152 may determine and/or generate eye-tracking data that indicates a direction and/or region at which a user looking. Eye gaze component 152 may be a combination of hardware and/or software that tracks movements and/or positions of a user's eye or portions of a user's eye.

For example, eye gaze component 152 may include a light- or image-capture device and/or a combination of hardware and/or software that determines or generates eye-tracking data that indicates a direction or region at which an iris, pupil or other portion of a user's eye is orientated towards. Based on the eye-tracking data, eye-tracking component 152 may generate a heat map or point distribution that indicates higher-densities or intensities closer to where a user is looking or where the user's vision or focus is directed, and lower densities or intensities where a user is not looking or where the user's vision or focus is not directed. In this way, eye-tracking data may be used in conjunction with techniques of this disclosure to determine where the user is not looking or where the user's vision or focus is not directed. Examples of eye-tracking tracking techniques that may be implemented in eye-tracking component 152 are described in “A Survey on Eye-Gazing Tracking Techniques”, Chennamma et al., Indian Journal of Computer Science and Engineering, Vol. 4 No. 5 October-November 2013, pp. 388-393 and “A Survey of Eye Tracking Methods and Applications”, Lupu et al., Buletinul Institutului Politehnic din Iaşi. Secţia Automatic\check{a} şi Calculatoare, Vol. 3 Jan. 2013, pp. 71-86, the entire contents of each of which are hereby incorporated by reference herein in their entirety. In some examples, eye-tracking component 152 may be a visual attention system that excludes portions of a physical scene before generating a scene description, where the excluded portions are portions identified or delineated based on a threshold corresponding to a probability that the driver is attentive to those one or more portions. For instance, if a probability that the driver is attentive to (e.g., focused on or vision is directed to) one or more portions satisfies the threshold (e.g., is greater than or equal to), then the one or more portions may be excluded before generating a scene description.

FIG. 1 illustrates physical scene 146. In some examples, a physical scene is an image, set of images, or field of view generated by an image capture device. The physical scene may be an image of an actual, physical natural environment or a simulated environment. The natural may be an image of a pathway and/or its surroundings, physical scenery, or conditions. For example, a physical scene may be an image of an urban setting with buildings, sidewalks, pathways, and associated objects (e.g., vehicles, pedestrians, pathway articles, to name only a few examples). Another physical scene may be an image of a highway or expressway with guardrails, surrounding fields, pathway shoulder areas, and associated objects (e.g., vehicles, pedestrians, pathway articles, to name only a few examples). Any number and variations of physical scenes are possible.

FIG. 1 illustrates a portion 150 of physical scene 146 where operator 148 is looking or where operator 148's vision or focus is directed. FIG. 1 also illustrates a portion 151 of physical scene 146 where operator 148 is not looking or where operator 148's vision or focus is not directed. Although portions 150, 151 are illustrated as elliptical in FIG. 1, portions 150 and 151 may be any shape based on eye-tracking data from eye-tracking component 152. Furthermore, although portions 150, 151 are shown as having uniform intensities for illustration purposes, in other examples, the intensities of focus or non-focus of operator 148 may be non-uniform.

Computing devices 134 (or “remote computing device 134”) may represent one or more computing devices other than computing device 116. In some examples, computing devices 134 may or may not be communicatively coupled to one another. In some examples, one or more of computing devices 134 may or may not be communicatively coupled to computing device 116.

Computing devices 134 may perform one or more operations in system 100 in accordance with techniques and articles of this system. Computing devices 134 may send and/or receive information that indicates one or more operations, rules, or other data that is usable by and/or generated by computing device 116 and/or vehicle 110. For example, operations, rules, or other data may indicate vehicle operations, traffic or pathway conditions or characteristics, objects associated with a pathway, other vehicle or pedestrian information, or any other information usable by or generated by computing device 116 and/or vehicle 110.

In the example of FIG. 1, interpretation component 118 may improve the relevance or quality of physical scene descriptions, which may be used to perform vehicle operations, by excluding portions of the physical scene at which the vision of a vehicle operator is directed during feature recognition. Interpretation component 118 may apply feature recognition techniques to an image of a physical scene 146 and classify or otherwise identify features in the image. A physical scene description generated by interpretation component 146 using feature recognition techniques may include identifiers or natural language representations of the features identified or classified in the image. Vehicle 110 and/or operator 148 may use such physical scene descriptions to perform various operations including alerting the operator 148, applying braking, turning, or changing acceleration. Because a physical scene 146 may include many features, some physical scene descriptions may be complex or contain more information than is necessary for a vehicle or vehicle operator to make decisions. This may be especially true if a vehicle operator is already looking at a portion of a physical scene that includes one or more features that the vehicle operator would or will react to. Overly complex or overly informative physical scene descriptions may cause a vehicle or vehicle operator to ignore or fail to recognize features (e.g., objects or conditions) in portions of a physical scene where the operator's vision is not directed. In such situations, the decision-making and/or safety of the vehicle or vehicle operator may be negatively impacted by ignoring or failing to recognize these features that are in portions of a physical scene other than where the operator's vision is directed.

Rather than interpretation component 118 generating a physical scene description based on entire physical scene 146, techniques of this disclosure implemented by interpretation component 118 may generate a description of the physical scene without the portion 150 of the physical scene 146 at which operator's vision is directed. In this way, the physical scene description may exclude descriptions of features that are already in the portion of the physical scene 146 where the vision of the operator 148 is directed (and therefore the operator would or will react to). Physical scene descriptions that exclude descriptions of features that are already in the portion of the physical scene 146 where the operator's 148 vision is directed may be more concise, less complex, and/or more relevant to a vehicle 110 or vehicle operator 148, thereby causing such physical scene descriptions generated using techniques of this disclosure to be more effective in vehicle or vehicle operator decision-making. In this way, safety and decision-making may be improved through the generation of physical scene descriptions of that exclude descriptions of features that are in the portion 150 of the physical scene at which vision of the operator is already directed.

In the example of FIG. 1, interpretation component 118 may receive, from image capture component 102C, one or more images of a physical scene 146 that is viewable by operator 148 of vehicle 110. Physical scene 146 may be at least partially in a trajectory of vehicle 110, as shown in FIG. 1. In other examples, physical scene 146 may be at least partially outside the trajectory of vehicle 110. In the example of FIG. 1, vehicle 110's trajectory is in the direction of dog 140 and pedestrian 142, and parallel to the lane markings of pathway 106.

Interpretation component 118 may receive, from eye-tracking sensor 152, eye-tracking data that indicates portion 150 of the physical scene at which vision of the operator is directed. In some examples, interpretation component 118 may receive, from eye-tracking sensor 152, eye-tracking data that indicates portion 151 of the physical scene at which vision of the operator is not directed. Interpretation component 118 may generate a heat map or point distribution that indicates higher- and lower-intensity values, respectively, based on whether the user's vision is more directed or focused towards locations or less directed or focused towards locations, within physical scene 146.

Interpretation component 118 may generate, based at least in part on excluding portion 150 of the physical scene 146 at which vision of operator 148 is directed, a description of physical scene 146. To generate the description of physical scene 146, interpretation component 118 may determine one or more portions of physical scene 146 based on where operator 148's vision is more directed or focused. Rather than generating a description of physical scene 146 based on the entire physical scene (e.g., using the entire image of physical scene 146 from image capture component 102C), interpretation component 118 may generate the physical scene description based on a portion 151 of the entire physical scene 146 that excludes or does not include portion 150 of the physical scene at which vision of the operator is directed. For example, interpretation component 118 may overlay or otherwise apply eye-tracking data, which may comprise intensity values of user vision or focus mapped to locations (e.g., cartesian coordinates on an X,Y plane), to the image of physical scene 146. As an example, an intensity value of a user's vision or focus may be mapped or otherwise associated with a location of a pixels or set of pixels in the image representing physical scene 146.

Interpretation component 146 may identify, select, or otherwise determine portion 150 of physical scene 146 at which vision of the operator 148 is directed. In some examples, interpretation component 146 may randomize the pixel values of portion 150 in the image that represents physical scene 146. In other examples, interpretation component 146 may crop, delete, or otherwise omit portion 150 from feature-recognition techniques applied to the modified image that represents physical scene 146. In still other examples, interpretation component 146 may change all pixel values in portion 150 to a pre-defined or determined value, such that portion 150 is entirely uniform. Using any of the aforementioned techniques or other suitable techniques that obscure, obfuscate, or remove portion 150 during feature-recognition, interpretation component 118 may generate a description of one or more remaining portions of physical scene 146 where vision of operator 148 is not directed.

Interpretation component 118 may implement one or more feature-recognition techniques that are applied to the image that represents physical scene 146. In some examples, the image may have been modified to include one or more portions that have been obscured, obfuscated, or removed using techniques described in this disclosure, such as through randomizing or modifying pixel values in portions of the image, deleting or cropping portions of the image, or ignoring portions of the image when performing feature-recognition. Examples of feature recognition techniques may include Scale-Invariant Feature Transform (SIFT) and Speeded Up Robust Features (SURF), to identify features in a physical scene. Interpretation component 118 may implement techniques of SIFT and/or SURF, which are described in “Distinctive Image Features from Scale-Invariant Keypoints”, David Lowe, International Journal of Computer Vision, 2004, 28 pp., and “SURF: Speeded Up Robust Features”, Bay et al., Computer Vision—ECCV 2006 Lecture Notes in Computer Science, vol 3951, 14 pp, the entire contents of each of which are hereby incorporated by reference herein in their entirety. In some examples, features may include or be objects and/or object features in a physical scene. Feature recognition techniques may identify features in a physical scene, which may then used by interpretation component 118 to identify, define, and/or classify objects based on the identified features. A description of a physical scene may include or be based on identities of features or objects in physical scene 146.

Although SIFT may be used in this disclosure for example purposes, other feature recognition techniques including supervised and unsupervised learning techniques, such as neural networks and deep learning to name only a few non-limiting examples, may also be used in accordance with techniques of this disclosure. In such examples, interpretation component 118 may apply image data that represents the visual appearance of features to a model and generate, based at least in part on application of the image data to the model, information that indicates features. For instance, the model may classify or otherwise identify features on the image data. In some examples, the model has been trained based at least in part on one or more training images comprising the features. The model may be configured based on at least one of a supervised, semi-supervised, or unsupervised technique. Example techniques may include deep learning techniques described in: (a) “A Survey on Image Classification and Activity Recognition using Deep Convolutional Neural Network Architecture”, 2017 Ninth International Conference on Advanced Computing (ICoAC), M. Sornam et al., pp. 121-126; (b) “Visualizing and Understanding Convolutional Networks”, arXiv:1311.2901v3 [cs.CV] 28 Nov. 2013, Zeiler et al.; (c) “Understanding of a Convolutional Neural Network”, ICET2017, Antalya, Turkey, Albawi et al., the contents of each of which are hereby incorporated by reference herein in their entirety. Other techniques that may be used in accordance with techniques of this disclosure include but are not limited to Bayesian algorithms, clustering algorithms, decision-tree algorithms, regularization algorithms, regression algorithms, instance-based algorithms, artificial neural network algorithms, deep learning algorithms, dimensionality reduction algorithms and the like. Various examples of specific algorithms include Bayesian Linear Regression, Boosted Decision Tree Regression, and Neural Network Regression, Back Propagation Neural Networks, the Apriori algorithm, K-Means Clustering, k-Nearest Neighbour (kNN), Learning Vector Quantization (LVQ), Self-Organizing Map (SOM), Locally Weighted Learning (LWL), Ridge Regression, Least Absolute Shrinkage and Selection Operator (LASSO), Elastic Net, and Least-Angle Regression (LARS), Principal Component Analysis (PCA) and Principal Component Regression (PCR).

Interpretation component 118 may generate labels, identifiers, or other indicia that identify various features of portions of the image of physical scene 146. Interpretation component 118 may generate a description of the physical scene based at least in part on excluding portion 150 of physical scene 146 at which the vision of operator 148 is directed. In some examples, a physical scene description may be a set of labels, identifiers, or other indicia that identify various features of portions of the image of physical scene 146, such as portion 151. A physical scene description may, for example, include words from a human-written or human-spoken language, such as “dog”, “pedestrian”, “pavement marking”, or “lane”. Interpretation component 118 may implement one or more language models that order or relate words (e.g., as a language relationship) based on pre-defined word relationships within the language model that indicate greater or lesser probabilities of relationships between words. Interpretation component 118 may determine one or more physical relationships between features or objects in a physical scene based on but not limited to: the physical relationships between features or objects in a physical scene, such as motion, direction, or distance; the physical orientation, location, appearance or properties of features or objects in a physical scene; or any other information that usable to establish relationships between words based on context. In other examples, a physical scene description may not comprise words from a human-written or human-spoken, but rather may be represented in a machine-structured format of identifiers of features or objects.

In the example of FIG. 1, interpretation component 118 may generate a first physical scene description “dog in left lane moving into vehicle trajectory” rather than a second physical scene description “dog in left lane moving into vehicle trajectory towards pedestrian in right lane moving into vehicle trajectory”. In this way, techniques of this disclosure implemented in interpretation component 118 may generate more concise, less complex and/or more relevant physical scene descriptions that are based on portions of physical scene 146 that operator 148's vision is not directed to. Accordingly, operations performed by computing device 116, such as generating alerts and/or modifying vehicle controls or behavior, may be based at least in part on the description of the physical scene that is generated based at least in part on excluding portion 150 of physical scene 146 at which the vision of operator 148 is directed.

In some examples, to perform at least one operation that based at least in part on the description of the physical scene, computing device 116 may be configured to select a level of autonomous driving for a vehicle that includes the computing device. In some examples, to perform at least one operation that is based at least in part on the information that corresponds to the physical scene computing device 116 may be configured to change or initiate one or more operations of vehicle 110A. Vehicle operations may include but are not limited to: generating visual/audible/haptic outputs or alerts, braking functions, acceleration functions, turning functions, vehicle-to-vehicle and/or vehicle-to-infrastructure and/or vehicle-to-pedestrian communications, or any other operations.

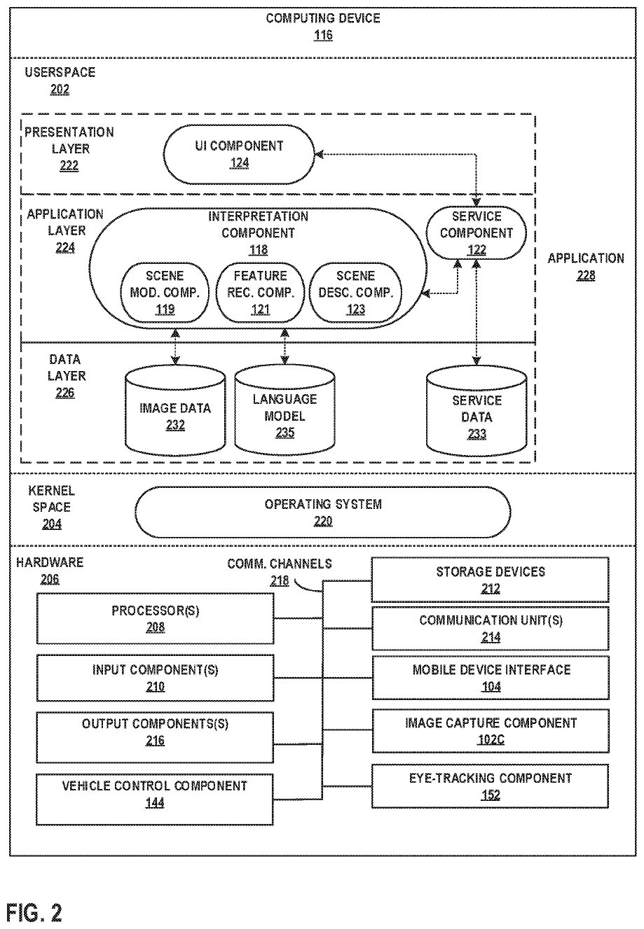

FIG. 2 is a block diagram illustrating an example computing device, in accordance with one or more aspects of the present disclosure. FIG. 2 illustrates only one example of a computing device. Many other examples of computing device 116 may be used in other instances and may include a subset of the components included in example computing device 116 or may include additional components not shown example computing device 116 in FIG. 2.

In some examples, computing device 116 may be an in in-vehicle computing device or in-vehicle sub-system, server, tablet computing device, smartphone, wrist- or head-worn computing device, laptop, desktop computing device, or any other computing device that may run a set, subset, or superset of functionality included in application 228. In some examples, computing device 116 may correspond to vehicle computing device 116 onboard vehicle 110, depicted in FIG. 1. In other examples, computing device 116 may also be part of a system or device that produces signs and correspond to computing device 134 depicted in FIG. 1.

As shown in the example of FIG. 2, computing device 116 may be logically divided into user space 202, kernel space 204, and hardware 206. Hardware 206 may include one or more hardware components that provide an operating environment for components executing in user space 202 and kernel space 204. User space 202 and kernel space 204 may represent different sections or segmentations of memory, where kernel space 204 provides higher privileges to processes and threads than user space 202. For instance, kernel space 204 may include operating system 220, which operates with higher privileges than components executing in user space 202.

In some examples, any components, functions, operations, and/or data may be included or executed in kernel space 204 and/or implemented as hardware components in hardware 206.

Although application 228 is illustrated as an application executing in userspace 202, different portions of application 228 and its associated functionality may be implemented in hardware and/or software (userspace and/or kernel space).

As shown in FIG. 2, hardware 206 includes one or more processors 208, input components 210, storage devices 212, communication units 214, output components 216, mobile device interface 104, image capture component 102C, and vehicle control component 144.

Processors 208, input components 210, storage devices 212, communication units 214, output components 216, mobile device interface 104, image capture component 102C, and vehicle control component 144 may each be interconnected by one or more communication channels 218.

Communication channels 218 may interconnect each of the components 102C, 104, 208, 210, 212, 214, 216, and 144 for inter-component communications (physically, communicatively, and/or operatively). In some examples, communication channels 218 may include a hardware bus, a network connection, one or more inter-process communication data structures, or any other components for communicating data between hardware and/or software.

One or more processors 208 may implement functionality and/or execute instructions within computing device 116. For example, processors 208 on computing device 116 may receive and execute instructions stored by storage devices 212 that provide the functionality of components included in kernel space 204 and user space 202. These instructions executed by processors 208 may cause computing device 116 to store and/or modify information, within storage devices 212 during program execution. Processors 208 may execute instructions of components in kernel space 204 and user space 202 to perform one or more operations in accordance with techniques of this disclosure. That is, components included in user space 202 and kernel space 204 may be operable by processors 208 to perform various functions described herein.

One or more input components 210 of computing device 116 may receive input.

Examples of input are tactile, audio, kinetic, and optical input, to name only a few examples. Input components 210 of computing device 116, in one example, include a mouse, keyboard, voice responsive system, video camera, buttons, control pad, microphone or any other type of device for detecting input from a human or machine. In some examples, input component 210 may be a presence-sensitive input component, which may include a presence-sensitive screen, touch-sensitive screen, etc.

One or more communication units 214 of computing device 116 may communicate with external devices by transmitting and/or receiving data. For example, computing device 116 may use communication units 214 to transmit and/or receive radio signals on a radio network such as a cellular radio network. In some examples, communication units 214 may transmit and/or receive satellite signals on a satellite network such as a Global Positioning System (GPS) network. Examples of communication units 214 include a network interface card (e.g. such as an Ethernet card), an optical transceiver, a radio frequency transceiver, a GPS receiver, or any other type of device that can send and/or receive information. Other examples of communication units 214 may include Bluetooth®, GPS, 3G, 4G, and Wi-Fi® radios found in mobile devices as well as Universal Serial Bus (USB) controllers and the like.

In some examples, communication units 214 may receive data that includes one or more characteristics of a physical scene or vehicle pathway. As described in FIG. 1, for purposes of this disclosure, references to determinations about physical scene 146 or vehicle pathway 106 and/or characteristics of physical scene 146 or vehicle pathway 106 may include determinations about physical scene 146 or vehicle pathway 106 and/or objects at or near physical scene 146 or vehicle pathway 106 including characteristics of physical scene 146 or vehicle pathway 106 and/or objects at or near physical scene 146 or vehicle pathway 106, such as but not limited to other vehicles, pedestrians, or objects. In examples where computing device 116 is part of a vehicle, such as vehicle 110 depicted in FIG. 1, communication units 214 may receive information about a physical scene from an image capture device, as described in relation to FIG. 1. In other examples, such as examples where computing device 116 is part of a system or device that produces signs, communication units 214 may receive data from a test vehicle, handheld device or other means that may gather data that indicates the characteristics of a vehicle pathway, as described above in FIG. 1 and in more detail below. Computing device 116 may receive updated information, upgrades to software, firmware and similar updates via communication units 214.

One or more output components 216 of computing device 116 may generate output. Examples of output are tactile, audio, and video output. Output components 216 of computing device 116, in some examples, include a presence-sensitive screen, sound card, video graphics adapter card, speaker, cathode ray tube (CRT) monitor, liquid crystal display (LCD), or any other type of device for generating output to a human or machine. Output components may include display components such as cathode ray tube (CRT) monitor, liquid crystal display (LCD), Light-Emitting Diode (LED) or any other type of device for generating tactile, audio, and/or visual output. Output components 216 may be integrated with computing device 116 in some examples.

In other examples, output components 216 may be physically external to and separate from computing device 116, but may be operably coupled to computing device 116 via wired or wireless communication. An output component may be a built-in component of computing device 116 located within and physically connected to the external packaging of computing device 116 (e.g., a screen on a mobile phone). In another example, a presence-sensitive display may be an external component of computing device 116 located outside and physically separated from the packaging of computing device 116 (e.g., a monitor, a projector, etc. that shares a wired and/or wireless data path with a tablet computer).

Hardware 206 may also include vehicle control component 144, in examples where computing device 116 is onboard a vehicle. Vehicle control component 144 may have the same or similar functions as vehicle control component 144 described in relation to FIG. 1.

One or more storage devices 212 within computing device 116 may store information for processing during operation of computing device 116. In some examples, storage device 212 is a temporary memory, meaning that a primary purpose of storage device 212 is not long-term storage. Storage devices 212 on computing device 116 may configured for short-term storage of information as volatile memory and therefore not retain stored contents if deactivated. Examples of volatile memories include random access memories (RAM), dynamic random access memories (DRAM), static random access memories (SRAM), and other forms of volatile memories known in the art.

Storage devices 212, in some examples, also include one or more computer-readable storage media. Storage devices 212 may be configured to store larger amounts of information than volatile memory. Storage devices 212 may further be configured for long-term storage of information as non-volatile memory space and retain information after activate/off cycles. Examples of non-volatile memories include magnetic hard discs, optical discs, floppy discs, flash memories, or forms of electrically programmable memories (EPROM) or electrically erasable and programmable (EEPROM) memories. Storage devices 212 may store program instructions and/or data associated with components included in user space 202 and/or kernel space 204.

As shown in FIG. 2, application 228 executes in userspace 202 of computing device 116. Application 228 may be logically divided into presentation layer 222, application layer 224, and data layer 226. Presentation layer 222 may include user interface (UI) component 228, which generates and renders user interfaces of application 228. Application 228 may include, but is not limited to: UI component 124, interpretation component 118 and one or more service components 122. For instance, application layer 224 may interpretation component 118 and service component 122. Presentation layer 222 may include UI component 124.

Data layer 226 may include one or more datastores. A datastore may store data in structure or unstructured form. Example datastores may be any one or more of a relational database management system, online analytical processing database, table, or any other suitable structure for storing data.

In the example of FIG. 2, interpretation component 118 may receive one or images of physical scenes, such as physical scene 146. In the example of FIG. 1, interpretation component 118 may receive, from image capture component 102C, one or more images (e.g., which may be stored as image data 232) of physical scene 146 that is viewable by operator 148 of vehicle 110. Interpretation component 118 may receive, from eye-tracking sensor 152, eye-tracking data that indicates portion 150 of the physical scene at which vision of the operator is directed. In some examples, interpretation component 118 may receive, from eye-tracking sensor 152, eye-tracking data that indicates portion 151 of the physical scene 146 at which vision of the operator is not directed. Interpretation component 118 may generate a heat map or point distribution that indicates higher- and lower-intensity values, respectively, based on whether the user's vision is more directed or focused towards locations or less directed or focused towards locations, within physical scene 146.

As described in FIG. 1, interpretation component 118 may generate, based at least in part on excluding portion 150 of the physical scene 146 at which vision of operator 148 is directed, a description of physical scene 146. To generate the description of physical scene 146, physical scene modifier component 119 may use eye-tracking data from eye-tracking component 152 to determine one or more portions of physical scene 146 based on where operator 148's vision is more directed or focused. Rather than generating a description of physical scene 146 based on the entire physical scene (e.g., using the entire image of physical scene 146 from image capture component 102C), physical scene description component 123 may generate the physical scene description based on a portion 151 of the entire physical scene 146 that excludes or does not include portion 150 of the physical scene at which vision of the operator is directed. For example, physical scene modification component 119 may overlay or otherwise apply eye-tracking data, which may comprise intensity values of user vision or focus mapped to locations (e.g., cartesian coordinates on an X,Y plane), to the image of physical scene 146. As an example, an intensity value of a user's vision or focus may be mapped or otherwise associated by physical scene modification component 119 with a location of a pixels or set of pixels in the image representing physical scene 146.

Physical scene modification component 119 may identify, select, or otherwise determine portion 150 of physical scene 146 at which vision of the operator 148 is directed. In some examples, physical scene modification component 119 may randomize the pixel values of portion 150 in the image that represents physical scene 146. In other examples, physical scene modification component 119 may crop, delete, or otherwise omit portion 150 from feature-recognition techniques applied to the modified image that represents physical scene 146. In still other examples, physical scene modification component 119 may change all pixel values in portion 150 to a pre-defined or determined value, such that portion 150 is entirely uniform. Using any of the aforementioned techniques or other suitable techniques that obscure, obfuscate, or remove portion 150 during feature-recognition, physical scene modification component 119 may prepare and provide an image to feature recognition component 121 that can be used to generate a description of one or more remaining portions of physical scene 146 where vision of operator 148 is not directed.

Feature recognition component 121 may implement one or more feature-recognition techniques that are applied to the image data from physical scene modification component 119 that represents physical scene 146. In some examples, the image may have been modified by physical scene modification component 119 to include one or more portions that have been obscured, obfuscated, or removed using techniques described in this disclosure, such as through randomizing or modifying pixel values in portions of the image, deleting or cropping portions of the image, or ignoring portions of the image when performing feature-recognition. As described in FIG. 1, examples of feature recognition techniques implemented in feature recognition component 121 may include but are not limited to Scale-Invariant Feature Transform (SIFT) and Speeded Up Robust Features (SURF), to identify features in a physical scene. Feature recognition component 121 may implement techniques of SIFT and/or SURF, which are described in “Distinctive Image Features from Scale-Invariant Keypoints”, David Lowe, International Journal of Computer Vision, 2004, 28 pp., and “SURF: Speeded Up Robust Features”, Bay et al., Computer Vision—ECCV 2006 Lecture Notes in Computer Science, vol 3951, 14 pp, the entire contents of each of which are hereby incorporated by reference herein in their entirety. In some examples, features may include or be objects and/or object features in a physical scene. Feature recognition techniques implemented in feature recognition component 121 may identify features in a physical scene, which may then used to identify, define, and/or classify objects based on the identified features. A description of a physical scene may be generated by physical scene description component 123 that includes or is based on identities of features or objects in physical scene 146. As described in FIG. 1, although SIFT may be used in this disclosure for example purposes, other feature recognition techniques including supervised and unsupervised learning techniques, such as neural networks and deep learning to name only a few non-limiting examples, may also be used by feature recognition component 121 in accordance with techniques of this disclosure.

Physical scene description component 123 may generate (or receive from feature recognition component 121) labels, identifiers, or other indicia that identify various features of portions of the image of physical scene 146. Physical scene description component 123 may generate a description of the physical scene based at least in part on physical scene modification component 119 excluding portion 150 of physical scene 146 at which the vision of operator 148 is directed. In some examples, a physical scene description may be a set of labels, identifiers, or other indicia that identify various features of portions of the image of physical scene 146, such as portion 151. Physical scene description component 123 may use or implement one or more language models 235 that order or relate words within the physical scene description based on, but not limited to: the physical relationships between features or objects in a physical scene, such as motion, direction, or distance; the physical orientation, location, appearance or properties of features or objects in a physical scene; pre-defined word relationships within the language model that indicate greater or lesser probabilities of relationships between words; or any other information that usable to establish relationships between words based on context. In other examples, a physical scene description may not comprise words from a human-written or human-spoken, but rather may be represented in a machine-structured format of identifiers of features or objects.

In the example of FIG. 1, physical scene description component 123 may generate a first physical scene description “dog in left lane moving into vehicle trajectory” rather than a second physical scene description “dog in left lane moving into vehicle trajectory towards pedestrian in right lane moving into vehicle trajectory”. In this way, techniques of this disclosure implemented in physical scene description component 123 may generate more concise, less complex and/or more relevant physical scene descriptions that are based on portions of physical scene 146 that operator 148's vision is not directed to. Accordingly, operations performed by service component 122, such as generating alerts and/or modifying vehicle controls or behavior, may be based at least in part on the description of the physical scene that is generated by physical scene description component 123 based at least in part on physical scene modification component 110 excluding portion 150 of physical scene 146 at which the vision of operator 148 is directed.

In some examples, to perform at least one operation that based at least in part on the description of the physical scene, service component 122 may be configured to select a level of autonomous driving for a vehicle that includes the computing device. In some examples, to perform at least one operation that is based at least in part on the information that corresponds to the physical scene, service component 122 may be configured to change or initiate one or more operations of vehicle 110. Vehicle operations may include but are not limited to: generating visual/audible/haptic outputs or alerts, braking functions, acceleration functions, turning functions, vehicle-to-vehicle and/or vehicle-to-infrastructure and/or vehicle-to-pedestrian communications, or any other operations.

Service component 122 may perform one or more operations based on the data generated by interpretation component 118. Service component 122 may, for example, query service data 233 to retrieve a list of recipients for sending a notification or store information relating to the physical scene (e.g., object to which pathway article is attached, image itself, metadata of image (e.g., time, date, location, etc.)). UI component 124 may send data to an output component of output components 216 that causes the output component to display the alert. In other examples, service component 122 may use service data 233 that includes information indicating one or more operations, rules, or other data that is usable by computing device 116 and/or vehicle 110. For example, operations, rules, or other data may indicate vehicle operations, traffic or pathway conditions or characteristics, objects associated with a pathway, other vehicle or pedestrian information, or any other information usable by computing device 116 and/or vehicle 110.

Similarly, service component 122, or some other component of computing device 116, may cause a message to be sent through communication units 214. The message could include any information, such as whether an article is counterfeit, operations taken by a vehicle, information associated with a physical scene, to name only a few examples, and any information described in this disclosure may be sent in such message. In some examples the message may be sent to law enforcement, those responsible for maintenance of the vehicle pathway and to other vehicles, such as vehicles nearby the pathway article.

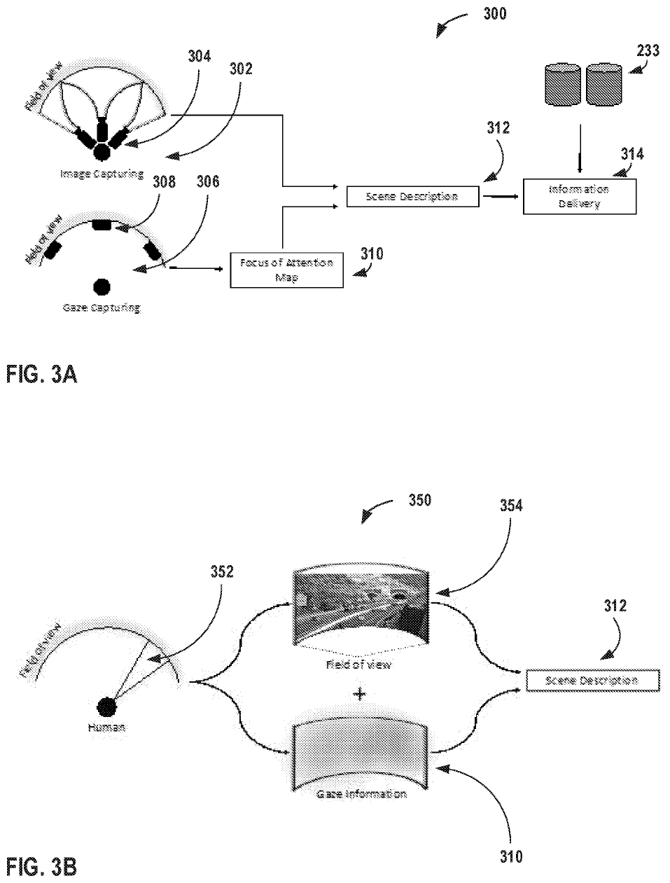

FIGS. 3A and 3B are conceptual diagrams of example systems, in accordance with this disclosure. System 300 of FIG. 3A illustrates an image capture system 302. Image capture system 302 may include a set of one or more image capture devices 304 that generate images of a field of view or physical scene. In some examples, multiple images from multiple image capture devices may be stitched or combined together by image capture system 302. In any case, image capture system 302 may provide the one or more images (whether stitched or not) to interpretation component 118 for processing as described in this disclosure. In some examples, each of the one or more image capture devices of image capture system 302 may be positioned at a vehicle, pathway, pathway article, pedestrian, or other object. In other words, one or more image capture devices of image capture system 302 may be positioned in different locations or at different objects, and each of the images may be used collectively by interpretation component 118 in accordance with techniques of this disclosure.

System 300 may include eye-tracking system 306. Eye-tracking system 306 may include a set of one or more eye-tracking components described in FIG. 1. Eye-tracking system 306 may capture or otherwise determine a user's gaze, focus, or direction of vision. In some examples, multiple sets of eye-tracking data may be combined or processed together by eye-tracking system 306. In any case, eye-tracking system 306 may provide eye-tracking data (whether combined together or individually) to interpretation component 118 for processing as described in this disclosure. In some examples, each of the one or more eye-tracking components of eye-tracking system 306 may be positioned at a vehicle, pathway, pathway article, pedestrian, or other object.

In other words, one or more eye-tracking components of eye-tracking system 306 may be positioned in different locations or at different objects, and each set of eye-tracking data may be used collectively by interpretation component 118 in accordance with techniques of this disclosure. For instance, eye-tracking system 306 may generate a focus of attention map 310 that indicates a heat map or point distribution that indicates higher-densities or intensities closer to where a user is looking or where the user's vision or focus is directed, and lower densities or intensities where a user is not looking or where the user's vision or focus is not directed. In this way, eye-tracking data may be used in conjunction with techniques of this disclosure to determine where the user is not looking or where the user's vision or focus is not directed.

As shown in FIG. 3A, interpretation component 118 may generate a physical scene description based on image data of a physical scene from image capture system 302 and a focus of attention map 310 from eye-tracking system 306. Physical scene description 312 may be used by services component 122, as described in FIG. 2, to perform one or more operations. For example, services component 122 may provide an information delivery service 314 that generates alerts for a user based on physical scene description 312 or sends messages to other computing devices based on physical scene description 312. In some examples, rules, conditions, or models that determine or otherwise indicate whether and/or when and/or to whom to provide the information delivery service 314 may be configured in service data 233, which may be local to computing device 116 and/or stored at one or more remote computing devices.

System 350 of FIG. 3B illustrates region 352 where a user's focus and/or vision is directed within a field of view or physical scene. Region 352 may be represented in data as a heat map or point distribution based on eye-tracking data from eye-tracking system 310. FIG. 3B illustrates an image 354 of a field of view or physical scene (e.g., physical scene 146) and a focus attention map 310 with eye-tracking data or gaze information based on region 352 where a user's focus and/or vision is directed within a field of view or physical scene. By superimposing or otherwise comparing or processing the locations of focus attention map 356 with the respective locations of image 354, interpretation component 118 may exclude portions of image 354 when generating a description of the physical scene. For instance, because focus attention map 310 indicates the user's focus and/or vision is directed to the upper-righthand corner of image 354, interpretation component 118 may generate the description 312 of the physical scene by excluding that portion image 354 during feature recognition and/or generation of the description of the physical scene. In this way, interpretation component 118 may generate more concise, less complex and/or more relevant physical scene descriptions 312 that are based on portions of image 354 that the user's vision is not directed to.

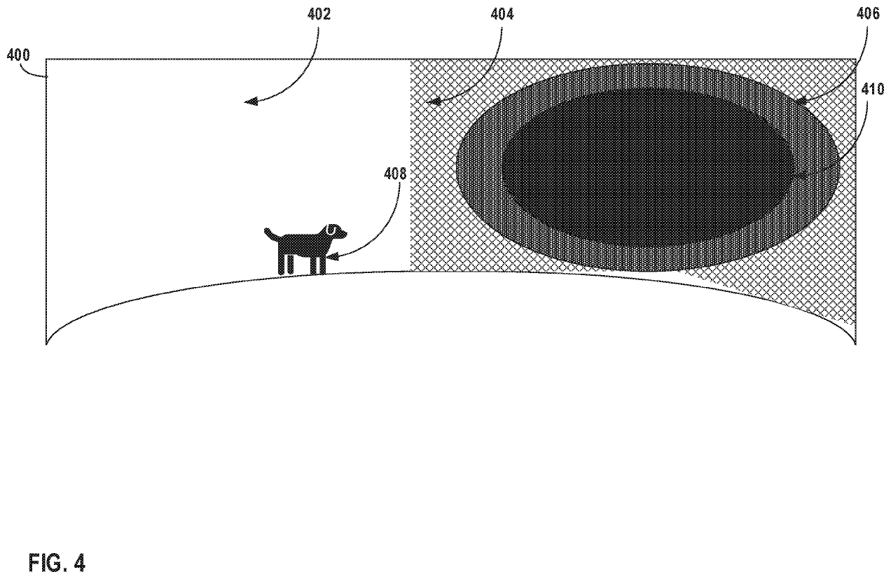

FIG. 4 is a conceptual diagram of a physical scene in accordance with techniques of this disclosure. In the example of FIG. 4, physical scene 400 may be the same as physical scene 146 of FIG. 1. In other examples, physical scene 400 may be different than physical scene 146 of FIG. 1. FIG. 4 illustrates a portion 406 of physical scene 400, which corresponds to the region where a user's vision or focused is directed. Portion 406 may be based on eye-tracking data generated by an eye-tracking component. The eye-tracking data may include a distribution of intensity values that indicate where a user's vision or focused is directed or is more or less likely directed.

As described in this disclosure, interpretation component 118 may generate, based at least in part on excluding portion 406 of physical scene 400 at which vision of the operator is directed, a description of the physical scene. In some examples, eye-tracking data may indicate a distribution of values at locations of a physical scene, where each value indicates a likelihood, score, or probability that a user's vision is focused or directed at a particular location or region of physical scene 400. For instance, the distribution of values may indicate higher or larger values at locations nearer to the centroid of portion 406 because the probability or likelihood that a user's vision is focused or directed at these locations near the centroid is higher. Conversely, the distribution of values may indicate lower or smaller values at locations farther from the centroid of portion 406 because the probability or likelihood that a user's vision is focused or directed at these locations near the centroid is lower.

In some examples, the perimeter or boundary of portion 406 may encompass all (e.g., 100%) of the values in the distribution of intensity values that indicate where a user's vision or focused is directed. In some examples, the perimeter or boundary of portion 406 may be defined by a set of lowest or smallest values in the distribution of intensity values, wherein the perimeter is a boundary formed by a set of segments between intensity values.

In some examples, the perimeter or boundary of the excluded portion of physical scene 400 at which vision of the operator is directed may encompass fewer than all of the values in the distribution of intensity values that indicate where a user's vision or focused is directed. For example, interpretation component may select or use portion 410 as the excluded portion of physical scene 400 at which vision of the operator is directed, although a subset of the overall set of intensity values in the distribution may reside outside of the perimeter or region of portion 410. In some examples, less than 20% of intensity values in the distribution may be outside portion 410 which is used by interpretation component 118 as the excluded portion of physical scene 400 at which vision of the operator is directed. In some examples, less than 10% of intensity values in the distribution may be outside portion 410 which is used by interpretation component 118 as the excluded portion of physical scene 400 at which vision of the operator is directed. In some examples, less than 5% of intensity values in the distribution may be outside portion 410 which is used by interpretation component 118 as the excluded portion of physical scene 400 at which vision of the operator is directed. Interpretation component 118 may use any number of suitable techniques to determine which values in the distribution are not included in portion 410, such as excluding the n-number of smallest or lowest intensity values, the n-number of intensity values that are furthest from the centroid or other calculated reference point within all intensity values in the distribution, or any other technique for identifying outlier or anomaly intensity values.

In some examples, the perimeter or boundary of the excluded portion of physical scene 400 at which vision of the operator is directed may encompass a larger area than an area that encompasses all of the values in the distribution of intensity values that indicate where a user's vision or focused is directed. For example, interpretation component may select or use portion 404 (e.g., half of physical scene 400) as the excluded portion of physical scene 400 at which vision of the operator is directed, although the entire set of intensity values in the distribution may reside within a smaller perimeter or region of portion 406. In some examples, less than 50% of physical scene 400 may be used by interpretation component 118 as the excluded portion 404. In some examples, less than 25% of physical scene 400 may be used by interpretation component 118 as the excluded portion 404. In some examples, less than 10% of physical scene 400 may be used by interpretation component 118 as the excluded portion 404. Interpretation component 118 may use any number of suitable techniques to determine the size of portion 404, such as increasing the perimeter or boundary that encompasses the entire distribution intensity values by n-percent, increasing the perimeter or boundary that encompasses a centroid of intensity values by n-percent, or any other technique for increasing the area surrounding a set of outermost intensity values from a centroid.

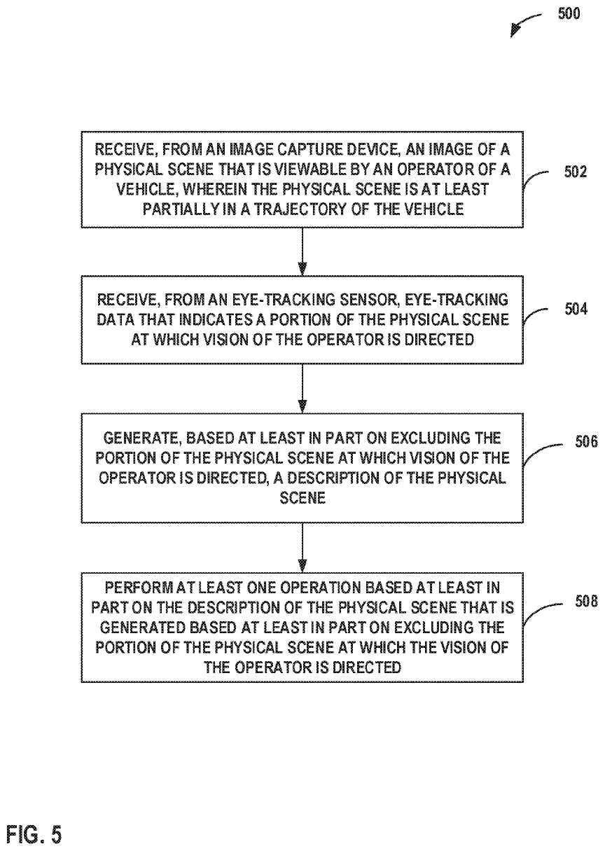

FIG. 5 is a flow diagram illustrating example operations 500 of a computing device, in accordance with one or more techniques of this disclosure. The techniques are described in terms of computing device 116. However, the techniques may be performed by other computing devices. In the example of FIG. 5, computing device 116 may receive, from an image capture device, an image of a physical scene that is viewable by an operator of a vehicle, wherein the physical scene is at least partially in a trajectory of the vehicle (502). Computing device 116 may receive, from an eye-tracking sensor, eye-tracking data that indicates a portion of the physical scene at which vision of the operator is directed (504). In some examples, computing device 116 may receive, from an eye-tracking sensor, eye-tracking data that indicates a portion of the physical scene at which vision of the operator is directed (506). Computing device 116 may perform at least one operation based at least in part on the description of the physical scene that is generated based at least in part on excluding the portion of the physical scene at which the vision of the operator is directed (508).

Although this disclosure has described the various techniques in examples with vehicles and operators of such vehicles, the techniques may be applied to any human or machine-based observer. For example, a worker in a work environment may similarly direct his vision to a particular portion or region of a physical scene. In another portion or region of the physical scene where the worker's vision is not directed may be a hazard. Applying techniques of this disclosure, a computing device may generate a scene description of a features, objects or hazards based on excluding the portion or region of the physical scene at which the worker's focus or vision is directed. For instance, an article of personal protective equipment for a firefighter may include a self-contained breathing apparatus. The self-contained breathing apparatus may include a headtop that supplies clean air to the firefighter. The headtop may include an eye-tracking device that determines where the focus or direction of the firefighter is directed. By excluding portions of a physical scene at which the firefighter's vision is directed or focused, techniques of this disclosure may be used to generate scene descriptions of hazards that the firefighter's vision is not focused on or directed to. Example systems for worker safety in which techniques of this disclosure may be implemented are described in U.S. Pat. No. 9,998,804 entitled “Personal Protective Equipment (PPE) with Analytical Stream Processing for Safety Event Detection”, issued on Jun. 12, 2018, the entire content of which is hereby incorporated by reference in its entirety. Example systems for firefighters or emergency responders in which techniques of this disclosure may be implemented are described in U.S. Pat. No. 10,139,282 entitled “Termal imaging system”, issued on Nov. 17, 2018, the entire content of which is hereby incorporated by reference in its entirety.

In accordance with techniques that may apply to users or workers, a computing device may include one or more computer processors, and a memory comprising instructions that when executed by the one or more computer processors cause the one or more computer processors to: receive, from an image capture device, an image of a physical scene that is viewable by a user, wherein the physical scene is at least partially in a field of view of a user; receive, from an eye-tracking sensor, eye-tracking data that indicates a portion of the physical scene at which vision of the user is directed; generate, based at least in part on excluding the portion of the physical scene at which vision of the user is directed, a description of the physical scene; and perform at least one operation based at least in part on the description of the physical scene that is generated based at least in part on excluding the portion of the physical scene at which the vision of the user is directed.

In one or more examples, the functions described may be implemented in hardware, software, firmware, or any combination thereof. If implemented in software, the functions may be stored on or transmitted over, as one or more instructions or code, a computer-readable medium and executed by a hardware-based processing unit. Computer-readable media may include computer-readable storage media, which corresponds to a tangible medium such as data storage media, or communication media including any medium that facilitates transfer of a computer program from one place to another, e.g., according to a communication protocol. In this manner, computer-readable media generally may correspond to (1) tangible computer-readable storage media, which is non-transitory or (2) a communication medium such as a signal or carrier wave. Data storage media may be any available media that can be accessed by one or more computers or one or more processors to retrieve instructions, code and/or data structures for implementation of the techniques described in this disclosure. A computer program product may include a computer-readable medium.

By way of example, and not limitation, such computer-readable storage media can comprise RAM, ROM, EEPROM, CD-ROM or other optical disk storage, magnetic disk storage, or other magnetic storage devices, flash memory, or any other medium that can be used to store desired program code in the form of instructions or data structures and that can be accessed by a computer. Also, any connection is properly termed a computer-readable medium. For example, if instructions are transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of medium. It should be understood, however, that computer-readable storage media and data storage media do not include connections, carrier waves, signals, or other transient media, but are instead directed to non-transient, tangible storage media. Disk and disc, as used, includes compact disc (CD), laser disc, optical disc, digital versatile disc (DVD), floppy disk and Blu-ray disc, where disks usually reproduce data magnetically, while discs reproduce data optically with lasers. Combinations of the above should also be included within the scope of computer-readable media.

Instructions may be executed by one or more processors, such as one or more digital signal processors (DSPs), general purpose microprocessors, application specific integrated circuits (ASICs), field programmable logic arrays (FPGAs), or other equivalent integrated or discrete logic circuitry. Accordingly, the term “processor”, as used may refer to any of the foregoing structure or any other structure suitable for implementation of the techniques described. In addition, in some aspects, the functionality described may be provided within dedicated hardware and/or software modules. Also, the techniques could be fully implemented in one or more circuits or logic elements.

The techniques of this disclosure may be implemented in a wide variety of devices or apparatuses, including a wireless handset, an integrated circuit (IC) or a set of ICs (e.g., a chip set). Various components, modules, or units are described in this disclosure to emphasize functional aspects of devices configured to perform the disclosed techniques, but do not necessarily require realization by different hardware units. Rather, as described above, various units may be combined in a hardware unit or provided by a collection of interoperative hardware units, including one or more processors as described above, in conjunction with suitable software and/or firmware.

It is to be recognized that depending on the example, certain acts or events of any of the methods described herein can be performed in a different sequence, may be added, merged, or left out altogether (e.g., not all described acts or events are necessary for the practice of the method). Moreover, in certain examples, acts or events may be performed concurrently, e.g., through multi-threaded processing, interrupt processing, or multiple processors, rather than sequentially.

In some examples, a computer-readable storage medium includes a non-transitory medium. The term “non-transitory” indicates, in some examples, that the storage medium is not embodied in a carrier wave or a propagated signal. In certain examples, a non-transitory storage medium stores data that can, over time, change (e.g., in RAM or cache).

Various examples of the disclosure have been described. These and other examples are within the scope of the following claims.

1. A computing device comprising:
one or more computer processors, and
a memory comprising instructions that when executed by the one or more computer processors cause the one or more computer processors to:
receive, from an image capture device, an image of a physical scene that is viewable by an operator of a vehicle, wherein the physical scene is at least partially in a trajectory of the vehicle;
receive, from an eye-tracking sensor, eye-tracking data that indicates a portion of the physical scene at which vision of the operator is directed;
generate, based at least in part on excluding the portion of the physical scene at which vision of the operator is directed, a description of the physical scene; and
perform at least one operation based at least in part on the description of the physical scene that is generated based at least in part on excluding the portion of the physical scene at which the vision of the operator is directed.

2. The computing device of claim 1, wherein to exclude the portion of the physical scene at which vision of the operator is directed, the memory comprises instructions that cause the one or more computer processors, when executed, to randomize pixel values of the portion of the physical scene in the image at which vision of the operator is directed and perform feature recognition on the entire image.

3. The computing device of claim 1, wherein to exclude the portion of the physical scene at which vision of the operator is directed, the memory comprises instructions that cause the one or more computer processors, when executed, to crop the portion of the physical scene in the image at which vision of the operator is directed and perform feature recognition on the remaining image.

4. The computing device of claim 1, wherein to exclude the portion of the physical scene at which vision of the operator is directed, the memory comprises instructions that cause the one or more computer processors, when executed, to set pixel values to a defined value within the portion of the physical scene in the image at which vision of the operator is directed and perform feature recognition on the entire image.

5. The computing device of claim 1, wherein the eye-tracking data comprises a distribution of values, wherein each respective value indicates a respective likelihood that vision of the operator is directed to a respective location of the physical scene.

6. The computing device of claim 5, wherein the portion of the physical scene at which vision of the operator is directed includes fewer than all of the values in the distribution of values.

7. The computing device of claim 5, wherein the portion of the physical scene at which vision of the operator is directed comprises an area that is larger than an area encompassing all of the values in the distribution of values.

8. The computing device of claim 1, wherein to generate a description of the physical scene, the memory comprises instructions that cause the one or more computer processors, when executed, to:
generate, based at least in part on applying feature recognition to the image, a set of descriptions that correspond to a set of features within the image;
generate the description of the physical scene based at least in part on the set of descriptions.

9. The computing device of claim 8, wherein to generate the description of the physical scene based at least in part on the set of descriptions, the memory comprises instructions that cause the one or more computer processors, when executed, to:
determine a relationship between at least two descriptions in the set of descriptions based at least in part on a language relationship between the at least two descriptions in a language model or a physical relationship between at least two features in the image.

10. The computing device of claim 1, wherein to perform at least one operation, the memory comprises instructions that cause the one or more computer processors, when executed, to:
change at least one function of a vehicle, send at least one message to a remote computing device, or generate at least one alert for output to the operator.

11. The computing device of claim 1, wherein the at least one alert indicates at least one feature or object in a portion of the physical scene at which vision of the operator is not directed.

12-14. (canceled)

15. A computing device comprising:
one or more computer processors, and
a memory comprising instructions that when executed by the one or more computer processors cause the one or more computer processors to:
receive, from an image capture device, an image of a physical scene that is viewable by a user, wherein the physical scene is at least partially in a field of view of a user;
receive, from an eye-tracking sensor, eye-tracking data that indicates a portion of the physical scene at which vision of the user is directed;
generate, based at least in part on excluding the portion of the physical scene at which vision of the user is directed, a description of the physical scene; and
perform at least one operation based at least in part on the description of the physical scene that is generated based at least in part on excluding the portion of the physical scene at which the vision of the user is directed.

16-18. (canceled)
